(19) United States
(12) Patent Application Publication
(10) Pub. No.: US 2005/0138768 A1
(43) Pub. Date: Jun. 30, 2005

(54) Caster

(76) Inventor: Tony Kuo, Tainan Hsien (TW)

Correspondence Address: Allston L. Jones;Peters, Verny, Jones & Schmitt, LLP, Suite 230, 425 Sherman Avenue, Palo Alto, CA, 94306, US

(21) Appl. No.: 10/747,834

(22) Filed: Dec. 29, 2003

(51) Int. Cl. B60B 33/00

(52) U.S. Cl. 16/38

(57) ABSTRACT

A caster includes first and second antifriction bearings which respectively have first and second outer race members disposed over and underneath a bearing seat of a fork frame, respectively. The first and second outer race members respectively have first and second smaller rivet holes aligned with a larger rivet hole in the bearing seat along a swivel axis to form a combined rivet hole. A swivel shaft is inserted into the combined rivet hole to form an annular space for receiving a tubular bracing member that is sleeved on the shaft. A point of the shaft is riveted to fasten the second outer race member. The impact force during riveting is transmitted to the head primarily through the bracing member.

### BACKGROUND OF THE INVENTION

1. Field of the Invention

This invention relates to a caster, more particularly to a caster including a swivel shaft which is riveted at a point thereof to retain an antifriction bearing unit thereon, thereby steadily supporting an appliance and permitting free movement of the appliance.

2. Description of the Related Art

Referring to FIGS. 1 and 2, a conventional caster 1 is shown to include a fork frame 12 with a bearing seat 121, and two legs 122 for rotatably mounting a wheel 11 therebetween by a rivet shaft 14, an antifriction bearing unit 13, and a swivel shaft 15. The antifriction bearing unit 13 includes first and second outer race members 132,133 disposed over and underneath the bearing seat 121, respectively, and having first and second rivet holes 136,137 which are aligned with a rivet hole 123 in the bearing seat 121, and a plurality of first and second balls 131,134 disposed between the first outer race member 132 and the bearing seat 121, and between the bearing seat 121 and the second outer race member 133, respectively. The swivel shaft 15 includes a distal segment 151 which is adapted to be connected securely to an appliance (not shown) to be moved, and a proximate segment 153 which extends downwardly from the distal segment 151, which is inserted into the rivet hole 123, and which is fitted into the first rivet hole 136 such that an enlarged head 152 which is formed around the proximate segment 153 adjacent to the distal segment 151 is disposed upwardly of the first outer race member 132. A lower portion 154 extends downwardly from the proximate segment 153 to project outwardly of the second outer race member 133 and a washer 135. The lower portion 154 is riveted to form a point 155 so as to fasten the second outer race member 133 and the washer 135.

The impact force during riveting of the lower portion 154 may be transmitted to the first and second outer race members 132,133 to reduce the distance therebetween, thereby adversely affecting the turning of the fork frame 12 relative to the swivel shaft 15. On the contrary, insufficient impact force applied to the lower portion 154 may result in unsteady connection between the swivel shaft 15 and the bearing seat 121. Moreover, the dimension of the proximate segment 153 of the swivel shaft 15 has to be controlled precisely so as to fit into the first rivet hole 136 in the first outer race member 132, thereby resulting in inconvenient formation of the swivel shaft 15 and the first outer race member 132.

### SUMMARY OF THE INVENTION

The object of the present invention is to provide a caster which can overcome the aforementioned problems associated with the prior art.

According to this invention, a caster includes a fork frame having a bearing seat and two legs which respectively extend downwardly in an upright direction from the bearing seat and which are spaced apart from each other in a transverse direction relative to the upright direction. The bearing seat has a larger rivet hole extending therethrough along a swivel axis in the upright direction.

A wheel is mounted between the legs for rotation about a wheel axis in the transverse direction.

A first antifriction bearing includes a first outer race member which is disposed over the bearing seat and which has a first smaller rivet hole that is aligned with the larger rivet hole along the swivel axis.

A second antifriction bearing includes a second outer race member which is disposed underneath the bearing seat and which has a second smaller rivet hole that is aligned with the larger rivet hole along the swivel axis so that the first and second smaller rivet holes and the larger rivet hole form a combined rivet hole.

A swivel shaft extends along the swivel axis, and includes a proximate segment which is configured such that when inserted into the combined rivet hole, the proximate segment is fitted into the first and second smaller rivet holes, and cooperates with the first and second outer race members to define an annular space, a head which is formed around the proximate segment and which is disposed upwardly of the first outer race member, and a point which is opposite to the head along the proximate segment and which projects outwardly of the second smaller rivet hole.

A tubular bracing member, which is made from a material that is more rigid than the proximate segment along the swivel axis, is sleeved movably on the proximate segment, and is configured to fit into the annular space such that when the point is riveted, the first outer race member abuts against the head through the tubular bracing member.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is an exploded perspective view of a conventional caster;

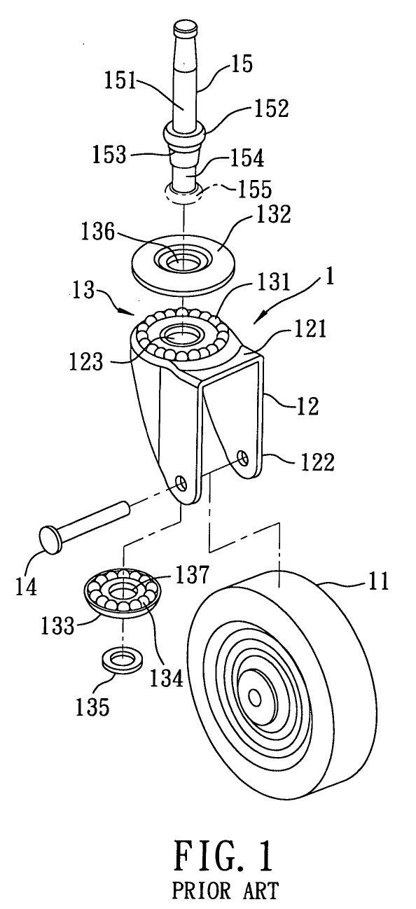

FIG. 2 is a partly sectional side view of the conventional caster;

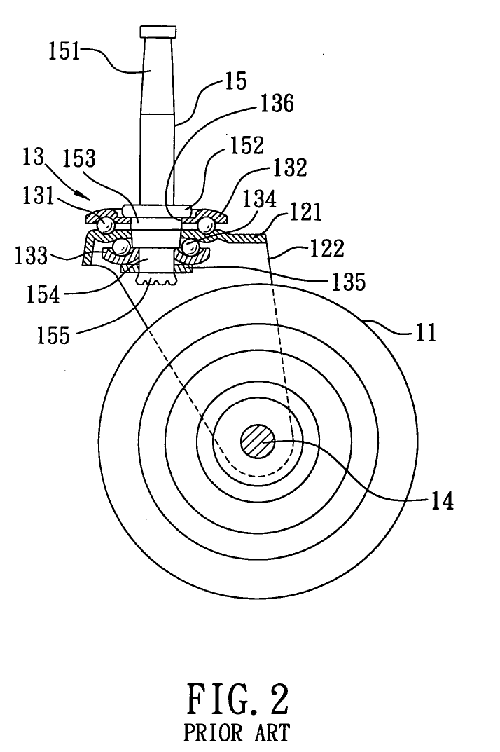

FIG. 3 is an exploded perspective view of the first preferred embodiment of a caster according to this invention;

FIG. 4 is a partly sectional side view of the first preferred embodiment;

FIG. 5 is a partly sectional side view of the second preferred embodiment according to this invention; and

FIG. 6 is a partly sectional side view of the third preferred embodiment according to this invention.

### DETAILED DESCRIPTION OF THE PREFERRED EMBODIMENTS

Before the present invention is described in greater detail, it should be noted that same reference numerals have been used to denote like elements throughout the specification.

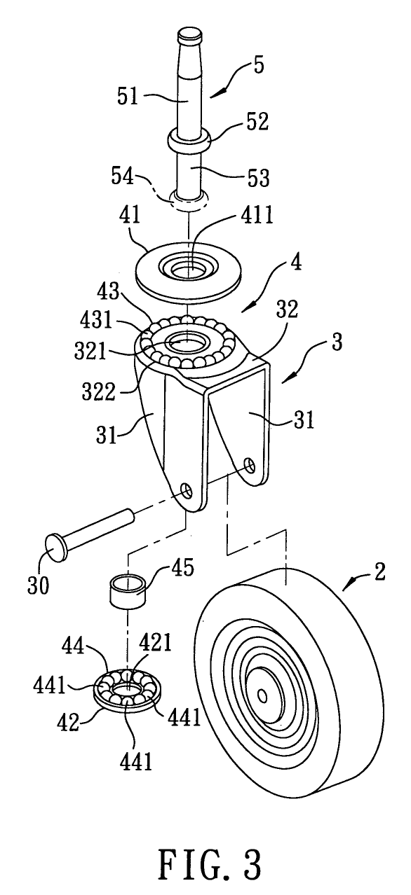

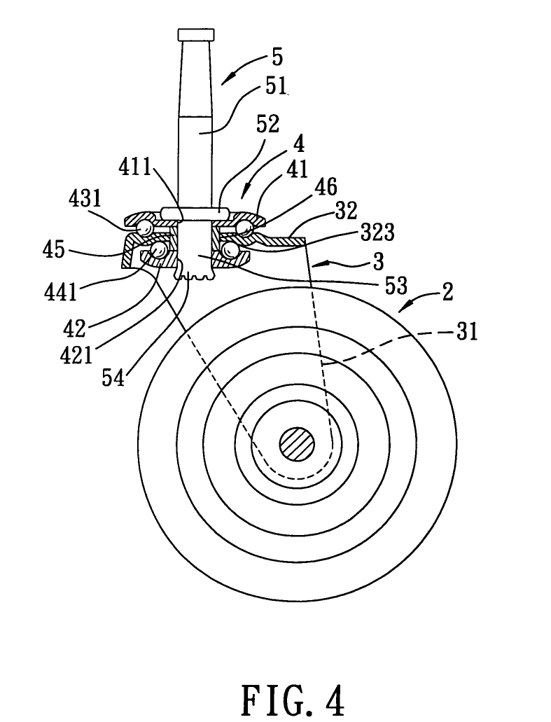

Referring to FIGS. 3 and 4, the first preferred embodiment of a caster according to the present invention is adapted to be assembled to an underside of an appliance (not shown). The caster is shown to comprise a fork frame 3, a wheel 2, an antifriction bearing unit 4, a swivel shaft 5, and a tubular bracing member 45.

The fork frame 3 includes a bearing seat 32 and two legs 31 which respectively extend downwardly in an upright direction from the bearing seat 32 and which are spaced apart from each other in a transverse direction relative to the upright direction. The bearing seat 32 has a larger rivet hole 321 which extends therethrough along a swivel axis in the upright direction.

The wheel 2 is mounted between the legs 31 by a pin 30 for rotation about a wheel axis in the transverse direction.

The antifriction bearing unit 4 includes first and second antifriction bearings 43,44. The first antifriction bearing 43 includes a first outer race member 41 which is disposed over the bearing seat 32 and which has a first smaller rivet hole 411 that is aligned with the larger rivet hole 321 along the swivel axis, a first inner race 322 which is formed on an upper surface of the bearing seat 32, and a plurality of balls 431 which are interposed between the first outer race member 41 and the first inner race 322. The second antifriction bearing 44 includes a second outer race member 42 which is disposed underneath the bearing seat 32 and which has a second smaller rivet hole 421 that is aligned with the larger rivet hole 321 along the swivel axis so that the first and second smaller rivet holes 411,421 and the larger rivet hole 321 form a combined rivet hole, a second inner race 323 which is formed on a lower surface of the bearing seat 32, and a plurality of balls 441 which are interposed between the second outer race member 42 and the second inner race 323.

The swivel shaft 5 is made from a malleable material, and extends along the swivel axis. The swivel shaft 5 includes a distal segment 51 which is adapted to be connected securely to the appliance, and a proximate segment 53 which extends downwardly from the distal segment 51 and which is inserted into the combined rivet hole. The proximate segment 53 is configured to be fitted into the first and second smaller rivet holes 411,421 and to cooperate with the first and second outer race members 41,42 to define an annular space 46. A manufactured head 52 is formed around the proximate segment 53 adjacent to the distal segment 51, and is disposed upwardly of the first outer race member 41. A point 54 is formed opposite to the head 52 along the proximate segment 53 and projects outwardly of the second smaller rivet hole 421.

The tubular bracing member 45 is made from a material that is more rigid than the proximate segment 53 along the swivel axis, and is sleeved movably on the proximate segment 53 to fit into the annular space 56. Thus, when the point 54 is riveted to fasten the second outer race member 42, the first outer race member 41 abuts against the head 52 through the tubular bracing member 45. By means of the tubular bracing member 45, the impact force during riveting is transmitted to the head 52 primarily through the tubular bracing member 45.

The method of forming a swivel joint for the caster of this invention includes the following steps:

(1) forming the larger rivet hole 321 in the bearing seat 32 of the fork frame 3;

(2) forming the first smaller rivet hole 411 in the first outer race member 41;

(3) forming the second smaller rivet hole 421 in the second outer race member 42;

(4) disposing the first outer race member 41 over the bearing seat 32 such that the first smaller rivet hole 411 is aligned with the larger rivet hole 321 along the swivel axis to form the combined rivet hole;

(5) forming the manufactured head 52 around the proximate segment 53 of the swivel shaft 5 and the point 54 that is opposite to the manufactured head 52 along the proximate segment 53, and that is made from a malleable material;

(6) inserting the proximate segment 53 into the combined rivet hole so as to form the annular space 46;

(7) sleeving the tubular bracing member 45 on the proximate segment 53 to fit into the annular space 46;

(8) disposing the second outer race member 42 underneath the bearing seat 32 such that the point 54 protrudes outwardly of the second smaller rivet hole 421; and

(9) riveting the point 54.

By means of the tubular bracing member 45 which has upper and lower edges respectively abutting against the first and second outer race members 41,42, to maintain the distance between the first and second outer race members 41,42, and since the impact force is transmitted to the manufactured head 52 primarily through the tubular bracing member 45 during riveting the point 54, the gap between the second outer race member 42 and the second inner race 323, and the gap between the first outer race member 41 and the first inner race 322 can be maintained, thereby resulting in smooth rolling of the balls 441,431. Moreover, precision of the dimension of the swivel shaft 5 for fitting into the first smaller rivet hole 411 in the first outer race member 41 can be reduced for facilitating formation of the swivel shaft 5.

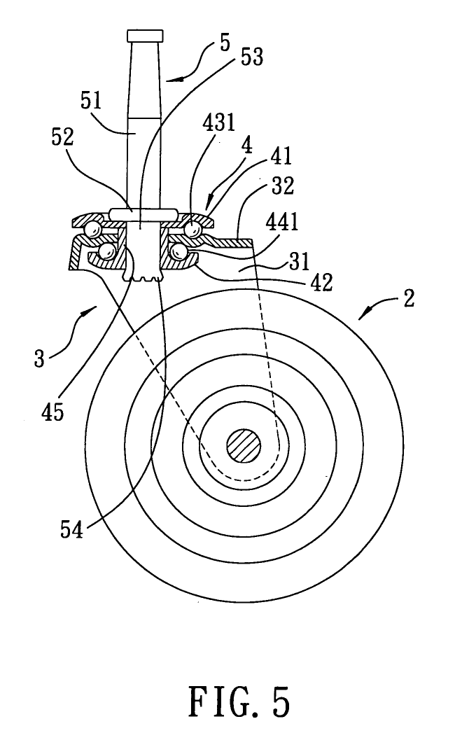

Referring to FIG. 5, the second preferred embodiment of a caster according to this invention is shown to be similar to the first preferred embodiment, except that the second outer race member 42 and the tubular bracing member 45 are integrally formed with each other. Hence, the aforesaid steps (7) and (8) can be performed simultaneously in the process of forming the caster.

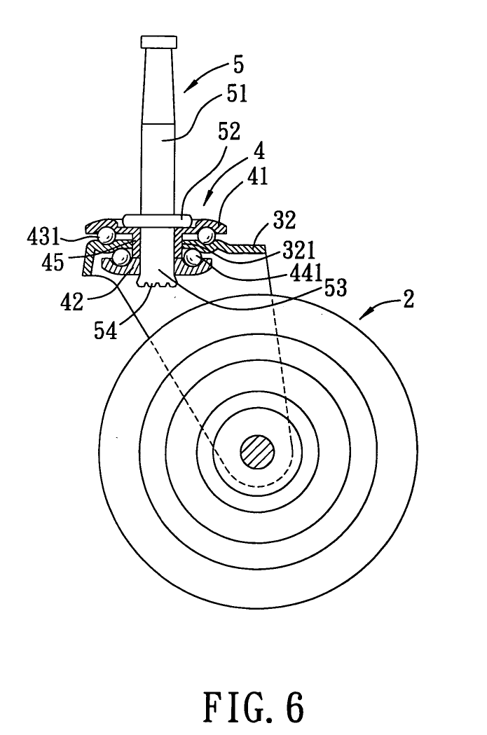

Referring to FIG. 6, the third preferred embodiment of a caster according to this invention is shown to be similar to the first preferred embodiment, except that the first outer race member 41 and the tubular bracing member 45 are integrally formed with each other. Thus, the tubular bracing member 45 is inserted into the larger rivet hole 321 in the bearing seat 32 in step (2) of the method of this invention.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

1. A caster comprising:
a fork frame having a bearing seat and two legs which respectively extend downwardly in an upright direction from said bearing seat and which are spaced apart from each other in a transverse direction relative to the upright direction, said bearing seat having a larger rivet hole extending therethrough along a swivel axis in the upright direction;
a wheel mounted between said legs for rotation about a wheel axis in the transverse direction;
a first antifriction bearing including a first outer race member which is disposed over said bearing seat and which has a first smaller rivet hole that is aligned with said larger rivet hole along the swivel axis;
a second antifriction bearing including a second outer race member which is disposed underneath said bearing seat and which has a second smaller rivet hole that is aligned with said larger rivet hole along the swivel axis so that said first and second smaller rivet holes and said larger rivet hole form a combined rivet hole;
a swivel shaft extending along the swivel axis, and including a proximate segment which is configured such that when inserted into said combined rivet hole, said proximate segment is fitted into said first and second smaller rivet holes and cooperates with said first and second outer race members to define an annular space, a head which is formed around said proximate segment and which is disposed upwardly of said first outer race member, and a point which is opposite to said head along said proximate segment and which projects outwardly of said second smaller rivet hole; and
a tubular bracing member made from a material that is more rigid than said proximate segment along the swivel axis, sleeved movably on said proximate segment, and configured to fit into said annular space such that when said point is riveted, said first outer race member abuts against said head through said tubular bracing member.

2. The caster of claim 1, wherein said tubular bracing member has upper and lower edges which abut against said first and second outer race members, respectively.

3. The caster of claim 1, wherein said tubular bracing member and said second outer race member are integrally formed with each other.

4. The caster of claim 1, wherein said first outer race member and said tubular bracing member are integrally formed with each other.
